(19) United States
(12) Patent Application Publication
(10) Pub. No.: US 2019/0207537 A1
(43) Pub. Date: Jul. 4, 2019

(54) Piezoelectric Zero-point Power Units

(71) Applicant: Anthony David Bressi, Danville, PA (US)

(72) Inventor: Anthony David Bressi, Danville, PA (US)

(73) Assignee: Shiva Science & Technology Group LLC, Lewisburg, PA (US)

(21) Appl. No.: 15/860,405

(22) Filed: Jan. 2, 2018

(51) Int. Cl. H02N 2/18

(52) U.S. Cl. CPC H02N 2/185

(57) ABSTRACT

Disclosed are devices which harness and manipulate a quantum effect to apply a cyclic, varying pressure to an integral piezoelectric element or elements to produce an electrical current. These devices utilize the Casimir Effect to efficiently produce more power than they consume during operation and can be used in place of most other electrical power sources, such as chemical batteries, in most contemporary applications and open the door to novel applications which may benefit from their ability to produce power without a need to recharge and over their lifespan.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### FIELD OF THE INVENTION

The present invention relates to power production and power harvesting.

### BACKGROUND OF THE INVENTION

The availability of energy has driven or hindered the technological development of the human race. The cheaper, more powerful, more compact, and more available power producing devices have become, so has technology advanced. Conversely, the lack of appropriate power producing devices can hinder the development and deployment of technologies. There is a lack of contemporary devices capable of acting as compact, portable power sources which are capable of furnishing power for extended periods of time without the need to be recharged and/or without the need to depend upon external factors, such as sunlight, for their energy.

Currently, the preferred portable power sources are chemical batteries; however, these suffer from serious short comings. These batteries rely upon chemical reactions to produce a current. These chemical reactions can be reversed by providing a reverse current in the case of recharging a rechargeable battery, but are irreversible for non-rechargeable batteries. This means that chemical batteries can only supply a finite amount of power without the need to be recharged or replaced.

Another downfall of chemical batteries and other portable power supply devices, such as supercapacitors and ultracapacitors, is that in order to provide power for a longer duration, they must be designed to have a very high energy density. This has created safety issues in regards to heat production during discharge and/or recharge, sometimes even resulting in fires. The present invention is not subject to these safety issues due to the method by which it produces power on demand rather than by storing it or by relying on exothermic chemical reactions to produce it.

In 1948, H. B. G. Casimir and D. Polder examined London—van der Waals' forces (intermolecular forces arising from instantaneously induced dipoles) in light of, the then new, quantum electrodynamics theory (QED). They found that the application of the concepts of mode restriction from quantum mechanics and retardation due to the limited speed of light yielded equations for the forces, that over small distances (tens of nanometers or less), behaved just as expected for the van der Waals' forces (based on equations derived by H. Hamaker in 1937, without QED). However, at larger distances, Casimir and Polder's equations also showed that there were stronger than expected forces (arising from the retardation effects).

In a subsequent paper, also in 1948, Casimir used these concepts to show that two uncharged, perfectly conducting plates separated by a vacuum would attract each other. This effect has subsequently become known as the “Casimir Effect” or “Casimir Force.” In 1954, E. M. Lifshitz extended this work to apply to real dielectric materials and to include temperature effects. In 1961, Lifshitz along with I. E. Dzyaloshinskii and L. P. Pitaevskii further generalized this work to account for situations where the intervening medium between the two dielectric half-spaces was not a vacuum and where the half-spaces could be different dielectrics.

This 1961 work also illuminated a possible way for changing the normally attractive Casimir Force into a repulsive force under certain circumstances. These circumstances involve systems where the intervening medium is a fluid with a permittivity that is intermediate to those of the two half-spaces comprising the boundaries of the Casimir-vdW cavity. In 2009, J. N. Munday, F. Capasso, and V. A. Parsegian demonstrated this method of generating a repulsive Casimir force by measuring it in a physical system (silica-bromobenzene-gold).

A major question regarding the practical use of the seemingly too good to be true, Casimir force to do work and produce power was answered in 1993 by D. C. Cole and H. E. Puthoff. They showed that it was possible to extract energy from the omnipresent vacuum energy (zero-point energy) and to do so irreversibly without violating the laws of thermodynamics through the Casimir—van der Waals' forces (henceforth Casimir-vdW forces). Therefore, if it could be harvested in a practical manner, zero-point energy manifested through the Casimir-vdW forces would provide an omnipresent and inexhaustible energy source. Experiments with a single-layer version prototype of the present invention in the laboratory have demonstrated that the present invention produces more electrical power than is supplied to the device.

Casimir-vdW forces are only substantial at very small dimensions (well under a micrometer). This has been a significant impediment to observing and quantifying them, let alone alone to exploiting them. In fact, the Casimir force wasn't convincingly demonstrated until a 1997 experiment by S. K. Lamoreaux. Furthermore, the “classical” form of the Casimir force (that between two parallel metal plates) wasn't experimentally demonstrated until 2002 by G. Bressi and others. Additionally, stiction of parts having very small separations (as a result of Casimir-vdW and electrostatic forces) has been a significant problem for the manufacture of the micromachines and engines normally envisioned for harvesting zero-point energy. Despite these problems, development of Casimir-vdW forces as a viable power source continues to attract attention because of its potential to produce energy without the need for fuel.

### BRIEF SUMMARY OF THE INVENTION

The present invention advantageously manipulates the quantum effect known popularly as the Casimir Effect, or Casimir-van der Waals Force, to produce electrical power on demand. It does this without utilizing chemical reactions to generate a current and does not need to be recharged like capacitors and some batteries in order to continue to act as a power source. The present invention utilizes appropriately structured and positioned materials of appropriate electric permittivity and/or magnetic permeability to generate a force via the Casimir-van der Waals force in conjunction with a means to disrupt said force on demand in order to exert a varying and/or cyclic pressure on one or more piezoelectric electrical generating elements and thus produce an electric current.

The promise of using the Casimir-vdW force to tap into what amounts to a possibly limitless source of “free” energy has led to much prior art being directed towards harvesting and harnessing this energy.

U.S. Pat. No. 5,123,039 issued to Shoulders includes disclosure of an apparatus and methods purporting to extract zero-point energy through the use of charged particles in a “traveling wave device.”

U.S. Pat. No. 7,411,772 issued to Tymes relates to apparati wherein the Casimir force produces a spin or applies a torque.

U.S. Pat. No. 7,379,286 issued to Haisch and Moddel describes a system where a fluid “take[s] in electromagnetic radiation from the ambient surroundings” thereby purportedly increasing the electron orbital energy levels of the fluid components and then “release[s] at least some of said energy when the fluid is caused to pass into a Casimir cavity.”

U.S. Pat. No. 7,501,788 issued to De Abreu involves the use of porous lead and lead dioxide plates in “doped acid solution” in a battery arrangement and “integrates quantum capacitors.”

U.S. Pat. No. 7,567,056 issued to De Abreu describes “quantum generators” composed of internal and external shells held either “in tension” or “in compression” states and “quantum generators” similar to those described in U.S. Pat. No. 7,501,788.

U.S. Pat. No. 8,317,137 issued to Cormier describes articles purportedly “for directly generating a lateral or transverse Casimir force.”

U.S. Patent Application No. 20100201133 by Mesler describes a transducer connected to an “arm rotatably coupled to the substrate.”

U.S. Patent Application No. 20110073715. by Macaulife describes an allegede “propellantless propulsion system” which supposedly extracts energy from “naturally occurring vacuum fluctuations” using “high-polarizability nanoparticles” formed into “nanoantennas.”

U.S. Patent Application No. 20120187872. by Camacho de Berm dez describes devices that purport to “attract and and store energy contained in a quantum vacuum” which are comprised of, among other items, “hybrid ceramic magnets,” metal plates, and a “linear particle accelerator.”

None of the above prior art envisages the use of the Casimir-vdW Effect as is it utilized in the present invention. In the present invention, a repulsive Casimir-vdW force is naturally generated by the presence of a fluid with appropriate electrical permittivity and/or magnetic permeability between two different, solid boundary layers possessing different electrical permittivities and/or magnetic permeabilities. One of said boundary layers is electrically conductive and this provides a means by which, by passing an electric current through or charging, said layer, said repulsive Casimir-vdW force may be negated and/or varied in magnitude and/or sign (i.e., made attractive).

The repulsive force generated is transmitted through the boundary layer(s) to a piezoelectric element or elements wherein a charge separation is generated between two opposing surfaces of said piezoelectric element(s). Conductors attached to said opposing surfaces of the piezoelectric element provide a means for connecting the surfaces via a circuit and allowing for the flow of an electric current.

By disrupting the natural repulsive Casimir-vdW forces within the device by periodic application of, and subsequent draining of, electric charge to the electrically conductive boundary layer, the piezoelectric element is able to produce said charge separation with each cycle and thus the electrical power produced by the device is related to the cyclic rate of the charging/discharging of said electrically conductive boundary layer and to the resonance frequencies of the components containing the piezoelectric element or elements.

The electrical current necessary to produce said disruption of the natural repulsive Casimir-vdW forces within the device may be obtained by diverting part of the output current from the piezoelectric element(s) within the device.

Thus, the present invention provides a compact power source which harnesses a quantum effect, itself arising from differences in quantum vacuum energy densities, and utilizes this effect to generate electric current on demand without the need to provide fuel or to recharge.

### BRIEF DESCRIPTION OF THE VIEW OF THE DRAWING

The foregoing aspects and others will be readily appreciated by the skilled artisan from the following description of illustrative embodiments when read in conjunction with the accompanying drawing.

FIG. 1 illustrates a cross-section of a portion of a multi-layer piezoelectric ZPU wherein, for sake of clarity, the different components are drawn out of scale with each other.

### DETAILED DESCRIPTION OF THE INVENTION

Before the invention is described in detail, it is to be understood that, unless otherwise indicated, this invention is not limited to particular embodiments, materials, and processes, as such may vary. It is also to be understood that the terminology used herein is for the purposes of describing particular embodiments only, and is not intended to be limiting.

As used in the specification and the appended claims, the singular forms “a,”“an,” and “the” include plural referents unless the context clearly indicates otherwise.

In this specification and the appended claims, reference will be made to a number of terms that shall be defined to have the following meanings:

The terms “optional” or “optionally” mean that the subsequently described feature or structure may or may not be present, or that the subsequently described event or circumstances may or may not occur, and that the description includes instances where a particular feature or structure is present and instances where it is not, or instances where the event or circumstance occurs and instances where it does not.

The term “electromagnetic” means pertaining to or involving the electromagnetic force, or its electric or magnetic components.

The term “permittivity” means the relative permittivity, also known as the dielectric constant, unless the context clearly indicates otherwise.

The term “permeability” means the relative magnetic permeability unless the context clearly indicates otherwise.

The term “material” can mean, depending upon the context, a homogenous material, glass, metal, ceramic, heterogenous composite, metamaterial, photonic crystal, liquid, solution, suspension, colloid, gas, plasma, or other substance or material not named, or a combination thereof.

The term “Casimir-vdW forces” means forces arising from the electromagnetic dipole interactions, from the differences in quantum vacuum energy densities between certain boundaries and/or spaces, or from the retardation effects arising from the finite speed of light. These forces are known under a variety of names, including: Casimir, Casimir-Polder, Lifshitz, Casimir-Lifshitz, can der Waals', and Casimir-van der Waals'.

The term “Casimir-vdW cavity” can either mean, based upon the context, the space between physical boundaries wherein Casimir-vdW forces arise or the structures comprised of both this space and the physical boundaries which generate the Casimir-vdW forces themselves.

Before embarking on descriptions of particular embodiments of the present invention, it would be beneficial to review some of the relevant theory.

QED postulates that the “vacuum” of empty space is not actually empty, but instead consists of a sea of “virtual” particles constantly popping in and out of existence. This is a fundamental component of quantum field theories such as QED. In QED, this sea of virtual particles is responsible for determining, among other things, the speed of light (in a vacuum), electric permittivity, and magnetic permeability. It also results in the small perturbations affecting dipoles which give rise to van der Waals' forces.

Van der Waals' forces is the catch-all name used to cover several electromagnetic dipole-dipole interactions. These are forces whose strength drops off rapidly with increasing separation distances. However, at very small separations, they exert significant forces and play a very important role in determining a material's phase properties (e.g., melting point, boiling point).

Another aspect of this sea of virtual particles in QED is due to the nature of light and its finite speed. This is called retardation. Quantum mechanics also restricts the “allowed” modes of the virtual particles between two appropriate boundaries. The combination results in the existence of a pressure differential in the pressure from the sea of virtual particles in the space between the two boundaries and the pressure exerted by the sea of virtual particles outside of the boundaries. This results in what is called the Casimir force. Since both the Casimir force and the van der Waals' forces arise due to the seas of virtual particles and can be derived from the same equations, they are sometimes referred to as Casimir-van der Waals' forces (henceforth, Casimir-vdW). These forces are responsible for a range of effects at small distances. These include adhesion, wetting, and stiction effects.

There are many ways of calculating Casimir-vdW forces. One of the more useful, and general, of these is to treat the Casimir-vdW cavity as being composed of mirrors and writing the interaction energy in terms of the reflection coefficients of these mirrors. The Casimir-vdW energy between two flat, smooth, dielectric plates parallel to each other; separated by a distance, a; and with an intervening fluid or vacuum (filling distance, a) can be written as:

$${E}_{123} ( a ) = \frac{hA}{4 {π}^{2}} {\sum }_{j = TE , TM} \int {d}^{2} \frac{Q}{4 {π}^{2}} {\int }_{0}^{∞} d ζln [ 1 - {R}_{31}^{j} {R}_{32}^{j} {e}^{- 2 {k}_{3} a} ]$$

where h is Planck's constant, A is the area, Q is the transverse wave vector, ξ is the frequency, the index j refers to the TE and TM polarization modes, the indices n refer to the cavity faces (1, 2) and intervening fluid (3) respectively, and the reflection coefficients R are given by

$${R}_{3 , n}^{TE} = \frac{{k}_{n} {μ}_{3} ( i ζ ) - {k}_{3} {μ}_{n} ( i ζ )}{{k}_{n} {μ}_{3} ( i ζ ) - {k}_{3} {μ}_{n} ( i ζ )}$$

$$and$$

$${R}_{3 , n}^{TM} = \frac{{k}_{n} {ϵ}_{3} ( i ζ ) - {k}_{3} {ϵ}_{n} ( i ζ )}{{k}_{n} {ϵ}_{3} ( i ζ ) - {k}_{3} {ϵ}_{n} ( i ζ )}$$

where εₙ(iξ) is the electric permittivity of component n at imaginary frequency iξ, μₙ(iξ) is the magnetic permeability of component n at imaginary frequency iξ, and

$${k}_{n}^{2} = Q - \frac{{ϵ}_{n} ( i ζ ) {μ}_{n} {ϵ}_{n} ( i ζ ) {ζ}^{2}}{{c}^{2}} .$$

The Casimir-vdW force is then given by

$${F}_{123} ( a ) = \frac{- d}{da} {E}_{123} ( a ) .$$

As can be seen from these equations, the direction (polarity) of the force can change from attractive to repulsive depending upon the permittivity and permeability values of the components and their arrangement relative to each other. In general, if

ε₁(iξ)μ₁(iξ)>ε₃(iξ)μ₃(iξ)>ε₂(iξ)μ₂(iξ)

holds over a significant range of frequencies, the force will be repulsive. Of course, it must be kept in mind that higher frequencies have higher energies and thus the permittivity/permeability behavior of the components at these frequencies contribute more than at the lower frequencies. However, at high enough frequencies, the cavity components become transparent and thus do not contribute to the Casimir-vdW forces.

All of the embodiments of the present invention rely on at least one component of the Casimir-vdW cavity to be electrically conductive, as the presence of an electrical charge will disrupt the Casimir Effect. This allows the force being exerted on the piezoelectric element to be reduced, negated, or reversed. This is important as it effects the power produced by the device and allows for altering the power output by enabling the alteration of the frequency with which the pressure is applied to the piezoelectric element and/or by controlling the magnitude of the pressure applied thereto.

Before turning to the preferred embodiments, one further design principle should be mentioned. Since the forces generated are dependent upon reflectivity, the faces (also called boundaries or half-spaces) of the Casimir-vdW cavity that are meant to be the principal generators of the Casimir-vdW forces within the cavity should be at least as thick as one-tenth their plasma wavelength (for metals this is, effectively, the “skin depth”). Several times this minimum thickness is preferred. This is because of the greatly reduced reflectivity near or thinner than this thickness. Lesser thicknesses could lead to substantially reduced force generation.

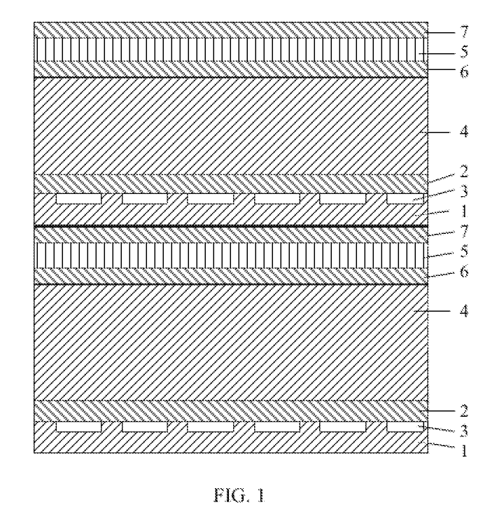

Now turning to the preferred embodiments of the present invention. FIG. 1 illustrates a small section of a multi-layer piezoelectric ZPU design. In this embodiment, repulsive Casimir-vdW forces are generated by the interaction between component 1 of suitable permittivity, a conductive component 2 of suitable permittivity when electrically neutral, and a fluid component 3 of suitable permittivity. The cavity in which fluid component 3 resides may be formed by standoffs incorporated into component 1 and/or component 2 components. The forces generated are mechanically transmitted through insulating component 4 along with electrically conductive component 6 and/or 7 to piezoelectric component 5 where the resulting pressure produces an electric field within the piezoelectric component 5.

By applying an electric current to component 2, the repulsive Casimir-vdW forces in the Casimir-vdW are diminshed, negated, or even turned into attractive forces. This relieves the pressure exerted on piezoelectric component 5. By turning off the electric current to component 2 and draining the charge on it, the normal repulsive Casimir-vdW forces are restored to the cavity. Thus, by applying an alternating current to component 2, a modulation of the forces exerted upon piezoelectric component 5 is achieved which results in an AC electric field. Conductive components 6 and 7 allow this AC electric field to be tapped and an AC electric current to be produced.

Now turning to the preferred methods of manufacturing the embodiments described herein. It is most beneficial to create subassemblies of the various components of the complete piezoelectric ZPU. This includes creation of a piezoelectric element subassembly composed of piezoelectric component 5 sandwiched between electrically conductive components 6 and 7. This is most readily accomplished by coating a piezoelectric sheet with electrically conductive coatings, most often, but not limited to metallic coatings or conductive inks, using techniques, or a combination of techniques, which produce coatings with minimal surface roughness.

Another subassembly which it is most beneficial to create is one composed of insulating component 4 and electrically conductive component 2. This is most readily accomplished by coating a sheet of insulating component 4 with an electrically conductive coating, most often a metal, utilizing techniques, or a combination of techniques, which produce a coating with a minimal surface roughness.

It is beneficial to produce the pattern of standoffs on Component 1. These standoffs may be produced by a number of methods, these include hot pressing, photolithography, electron beam etching, ion beam etching, and laser ablation.

Once the appropriate number of the previously described subassemblies are prepared they may be assembled into the proper configuration to produce the desired piezoelectric ZPU structure. The appropriate electrical connections may then be made. The assembly may be placed into an appropriate housing. Fluid component 3 may then be added. Connections to the driving, power conditioning, and output circuits and/or connectors may then be made.

Other methods of manufacturing various embodiements may utilize one technique, or a combination of techniques, such as hot pressing, photolithography, laser ablation, electron beam lithography, ion beam lithography, or other nanofabrication methods, to create the standoff patterns. Techniques such as chemical vapor deposition, molecular beam epitaxy, and/or other deposition techniques may be utilized to produce one or more of the various components. The device may be manufactured as one piece or made in subassemblies and subsequently assembled to form the piezoelectric ZPU. Appropriate electrical connections may be added where and when appropriate.

Piezoelectric ZPUs are compact, versatile energy sources that never require refueling and are environmentally sound to operate. Embodiments may be utilized for powering mobile computing devices and/or mobile communications devices. Land, sea, air, and/or space transportation vehicles, manned and/or unmanned, may also be powered by embodiments of the piezoelectric ZPU. The power output from piezoelectric ZPUs may also be utilized to power home appliances, industrial appliances, and/or other devices, and/or applications, which utilize electrical power, including as a replacement for chemical, and/or other, batteries.

### REFERENCES

H. B. G. Casimir and D. Polder, The Influence of Retardation on the London-van der Waals Forces, Physical Review 73(4): 360-372 (1948).

H. C. Hamaker, The London-van der Waals Attraction Between Spherical Particles, Physica 4(10): 1058-1072 (1937).

H. B. G. Casimir, On the attraction between two perfectly conducting plates, Proc. K. Ned. Akad. Wet. 51: 793-795 (1948).

E. M. Lifshitz, The Theory of Molecular Attractive Forces between Solids, Soviet Physics JETP 2(1): 73-83 (1956).

I. E. Dzyaloshinskii, E. M. Lifshitz, and L. P. Pitaevskii, General Theory of van der Waals' forces, Soviet Physics Uspekhi 4(2): 153-176 (1961).

J. N. Munday, F. Capasso, and V. A. Parsegian, Measured long-range repulsive Casimir-Lifshitz forces, Nature 457: 170-173 (2009).

T. H. Boyer, Van der Waals forces and zero-point energy for dielectric and permeable materials, Physical Review A 9: 2078-2084 (1974).

O. Kenneth, I. Klich, A. Mann, and M. Revzen, Repulsive Casimir forces, Physical Review Letters 89: 033001 (2002).

D. C. Cole and H. E. Puthoff, Extracting energy and heat from the vacuum, Physical Review E 4(2): 1562-1565 (1993).

S. K. Lamoreaux, Demonstraction of the Casimir force in the 0.6 to ***m range, Physical Review Letters 78: 5-8 (1997).

G. Bressi, G. Carugno, R. Onofrio, and G. Ruoso, Measurement of the Casimir force between parallel metallic surfaces, Physical Review Letters 88: 041804 (2002).

M. A. Shapiro, G. Shvets, J. R. Sirigiri, and R. J. Temkin, Spatial dispersion in metamaterials with negative dielectric permittivity and its effects on surface waves, Optics Letters 31(13): 2051-2053 (2006).

P. J. van Zwol, G. Palasantzas, and J. T. M. De Hosson, The influence of dielectric properties on van der Waals/Casimir forces in solid-liquid systems, Physical Review B 79: 195428 (2009).

A. W. Rodriguez, F. Capasso, and S. G. Johnson, The Casimir effect in microstructured geometries, Nature Photonics 5: 211-221 (2011).

I claim:

1) A device comprising:
(a) a structure containing at least one Casimir-vdW cavity which while in operation contains for some portion of time within some portion of said cavity, a fluid;
(b) wherein said fluid possesses electromagnetic properties which contribute to the Casimir-vdW forces generated within said Casimir-vdW cavity;
(c) wherein some portion of said Casimir-vdW forces are transmitted to a piezoelectric element;
(d) wherein said structure includes a component which may be utilized to reduce, negate, or reverse said Casimir-vdW forces; and,
(e) wherein said structure includes a component by which said Casimir-vdW forces exerted upon said piezoelectric element may be reduced, negated, or reversed by means of applying an electric charge or electric current to said component.

2) The device of claim 1 wherein a multiplicity of said Casimir-vdW cavities is incorporated therein.

3) The device of claim 2 wherein the Casimir-vdW cavities are arranged in a single layer.

4) The device of claim 2 wherein the Casimir-vdW cavities are arranged in multiple layers.

5) The device of claim 4 wherein the Casimir-vdW cavities are arranged in such a manner as to exert Casimir-vdW forces upon at least one piezoelectric element from opposing directions.

6) The device of claim 1 when used to generate an electric current.

7) The device of claim 2 when used to generate an electric current.

8) The device of claim 3 when used to generate an electric current.

9) The device of claim 4 when used to generate an electric current.

10) The device of claim 5 when used to generate an electric current.

11) A method of manufacturing the device of claim 3 comprising:
(a) the creation of standoffs in one or more components by means of hot pressing, photolithography, electron beam etching, ion beam etching, or laser ablation;
(b) the creation of a subassembly comprised of at least one electrically conductive component joined to an electrically insulating component;
(c) the creation of a subassembly comprised of at least one piezoelectric component joined to at least one electrically conductive component; and,
(d) the assembly of said subassemblies and any other needed components to create the device of claim 3.

12) A method of manufacturing the device of claim 4 comprising:
(a) the creation of standoffs in two or more components by means of hot pressing, photolithography, electron beam etching, ion beam etching, or laser ablation;
(b) the creation of subassemblies comprised of at least one electrically conductive component joined to an electrically insulating component;
(c) the creation of subassemblies comprised of at least one piezoelectric component joined to at least one electrically conductive component; and,
(d) the assembly of said subassemblies and any other needed components to create the device of claim 4.

13) A Method of manufacturing the device of claim 5 comprising:
(a) the creation of standoffs in two or more components by means of hot pressing, photolithography, electron beam etching, ion beam etching, or laser ablation;
(b) the creation of subassemblies comprised of at least one electrically conductive component joined to an electrically insulating component;
(c) the creation of subassemblies comprised of at least one piezoelectric component joined to at least one electrically conductive component; and,
(d) the assembly of said subassemblies and any other needed components to create the device of claim 4.A method of manufacturing the device of claim 4 comprising:
(a) the creation of standoffs in two or more components by means of hot pressing, photolithography, electron beam etching, ion beam etching, or laser ablation;
(b) the creation of subassemblies comprised of at least one electrically conductive component joined to an electrically insulating component;
(c) the creation of subassemblies comprised of at least one piezoelectric component joined to at least one electrically conductive component; and, (d) the assembly of said subassemblies and any other needed components to create the device of claim 5.

14) The device of claim 3 when used for providing power to an integrated circuit.

15) The device of claim 4 when used for providing power to a mobile communications device or a mobile computing device.

16) The device of claim 5 when used for providing power to a mobile communications device or a mobile computing device.

17) The device of claim 4 when used for providing power to a means of propulsion for a land, sea, air, or space vehicle.

18) The device of claim 5 when used for providing power to a means of propulsion for a land, sea, air, or space vehicle.

19) The device of claim 4 when used in place of a chemical, thermal, or nuclear battery; fuel cell; electrical power grid; electrical generator; electrical power plant; or other means of providing electrical power.

20) The device of claim 5 when used in place of a chemical, thermal, or nuclear battery; fuel cell; electrical power grid; electrical generator; electrical power plant; or other means of providing electrical power.
